(19) United States
(12) Patent Application Publication
(10) Pub. No.: US 2017/0010821 A1
(43) Pub. Date: Jan. 12, 2017

(54) ARCHITECTURE AND METHOD FOR UPDATING FIRMWARE OF STORAGE DEVICE

(71) Applicant: ACCELSTOR, INC., NEW TAIPEI CITY (TW)

(72) Inventors: PAN-LUNG TSAI, NEW TAIPEI CITY (TW); SHIH-CHIEH WENG, NEW TAIPEI CITY (TW)

(21) Appl. No.: 14/954,032

(22) Filed: Nov. 30, 2015

(30) Foreign Application Priority Data
Jul. 9, 2015 (TW) 104122322

(51) Int. Cl. G06F 3/06

(52) U.S. Cl. CPC G06F 3/0607; G06F 3/0688; G06F 3/0655

(57) ABSTRACT

The present invention provides an architecture and method for updating firmware storage device. The architecture comprises a host device and at least one storage device. The host device comprises at least one first firmware. The storage device comprises a controller and a first storage unit. The host device transmits the first firmware to the storage device. The controller loads the first firmware to the first storage unit, and executes one or more operation action according to an operation behavior defined by the first firmware. When the storage device is in boot state, it will ready to receive the first firmware provided from the host device, and update firmware by the first firmware. When the storage device is in shutdown state, the first firmware will disappear from the storage device so as to avoid other unauthorized host device to arbitrarily access the storage device by using the first firmware.

### CROSS-REFERENCE TO RELATED APPLICATIONS

This non-provisional application claims priority claim under 35 U.S.C. §119(a) on Taiwan Patent Application No. 104122322 filed Jul. 9th, 2015, the entire contents of which are incorporated herein by reference.

### FIELD OF THE INVENTION

The present invention is related to an architecture and method for updating firmware, particularly to an architecture and method being able to direct update a firmware of a storage device via a host device.

### BACKGROUND

Firmware is the key for determining the performance of a storage device, for example, hard disk or flash memory device. In addition to controller, the functions of firmware wound also affect the performance and the stability of the storage device. A writing excellent firmware program not only can help to correct the bug, which affects the operation speed of the storage device, but also add more application functions so as to increase the additional value of the storage device.

Formerly, firmware used by the storage device is defined within the storage device. When the storage device is want to perform the firmware updating, the host device needs to be shut down, such that the storage device is able to be pulled out from the host device, and then the storage device is connected with a programming device. Sequentially, the programming device burns a firmware program to the read only memory (ROM) of the storage device by a dedicated program (such as burning program) so that the firmware the storage device may be updated. After the storage device has been update firmware, the storage device is connected to the host device again, and then the host device reboots, such that the storage device will be able to use the updated firmware.

The firmware of the storage device can be updated by the above formerly way, in which the steps of updating firmware are very cumbersome. Besides, whenever the storage device wants to update the firmware, the host device needs to perform the boot up and the shutdown action, which will cause the inconvenience for the use of the host device. Furthermore, when the host device is a server, the internal of which usually configures a large number of storage devices, if every storage device adopts the formerly way to update the firmware, which will cause many burdens for manpower.

### SUMMARY

It is one object of the present invention to provide an architecture and method for updating firmware, in which the architecture comprises a host device and at least one storage device. The host device stores at least one first firmware, which is for defining a operation behavior to be executed by the storage device. The host device is able to transmit the first firmware to the storage device, the controller of the storage device loads the first firmware into the first storage unit, and executes at least one operation action according to the operation behavior defined by the first firmware. Thus, when the storage device is in boot state, it will ready to receive the first firmware provided by the host device, and therefore update firmware data, so as to increase the convenience in the firmware updating process.

It is another object of the present invention to provide an architecture and method for updating firmware, in which the host device is connected with a lot of storage devices. The host device is able to transmit the first firmware to all of the storage devices via a firmware management program, so that the firmware of all of the storage devices may be updated in the same time.

It is another object of the present invention to provide an architecture and method for updating firmware, in which the first storage unit of the storage device is a random access memory (RAM). When the storage device is in shutdown state (or called as power outage state), the first firmware temporary stored in the first storage unit will disappear, so as to avoid other unauthorized host device to arbitrarily access the data of the flash memory by the use of the first firmware within of the storage device.

For achieving above objects, the present invention provides an architecture for updating firmware of storage device, comprising: a host device, comprising a processor and a host storage, the processor being connected to the host storage, wherein the host storage stores at least one first firmware, each first firmware defines an operation behavior, respectively; and at least one storage device, comprising a controller, a flash memory, and a first storage unit, the controller being connected to the flash memory and the first storage unit, when the host device transmits the first firmware to the storage device, the controller of the storage device loads the first firmware into the first storage unit, and executes at least one operation action according to the operation behavior defined by the first firmware.

In one embodiment of the present invention, wherein the first storage unit is a random access memory, the first firmware is temporary stored in the first storage unit.

In one embodiment of the present invention, wherein the storage device further comprises a second storage unit connected to the controller, the second storage unit is a read only memory and stores a second firmware, and the controller of the storage device is allowed to execute a boot process by the use of the second firmware.

In one embodiment of the present invention, wherein the host storage of the host device further stores a firmware management program, the host device selects at least one first firmware, which is for defining the operation behavior to be executed by the storage device, via the firmware management program, and then transmits the selected first firmware to the storage device.

In one embodiment of the present invention, wherein the host device is connected with a plurality of storage devices, the host device transmits the first firmware to all of storage devices via the firmware management program.

In one embodiment of the present invention, wherein the controller comprises a loader unit, the first firmware is loaded into the first storage unit via the loader unit.

In one embodiment of the present invention, wherein the host device further comprises a first encryption and decryption unit, the storage device further comprises a second encryption and decryption unit, the host device encrypts the first firmware via the first encryption and decryption unit, and the storage device decrypts the first firmware via the second encryption and decryption unit.

In one embodiment of the present invention, wherein the first encryption and decryption unit and the second encryption and decryption unit are stored in the host storage and the flash memory based on software forms, respectively.

The present invention another provides a method for updating firmware of storage device, the method applied to a firmware updating process between a host device and at least one storage device, the host device comprising a processor and a host storage, the host storage storing at least one first firmware, each first firmware defining an operation behavior, respectively, the storage device comprising a controller and a first storage unit, the method comprising the following steps of: transmitting the first firmware to the storage device via the host device; receiving the first firmware and loading the first firmware into the first storage unit via the controller of the storage device; and executing at least one operation action according to the operation behavior defined by the first firmware via the controller of the storage device.

In one embodiment of the present invention, further comprising the following steps: encrypting the first firmware before the host device transmits the first firmware; and decrypting the first firmware after the storage device receives the first firmware.

### BRIEF DESCRIPTION OF THE DRAWINGS

FIG. 1 is a structural diagram of an architecture for updating firmware of storage device according to one embodiment of the present invention.

FIG. 2 is a structural diagram of an architecture for updating firmware of storage device according to another embodiment of the present invention.

### DETAILED DESCRIPTION OF THE PREFERRED EMBODIMENTS

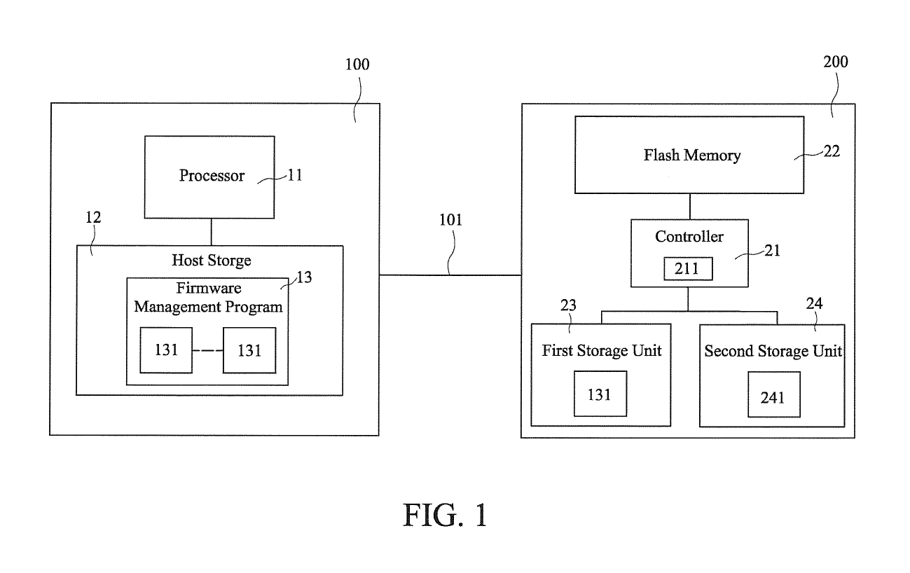

Referring to FIG. 1, there is shown a structural diagram of an architecture for updating firmware of storage device according to one embodiment of the present invention. As shown in FIG. 1, the architecture for updating firmware comprises a host device 100 and at least one storage device 200. The storage device 200 is a hard disk, a memory card, or a flash drive. The storage device 200 is connected to the host device 100. The host device 100 is allowed to transmit data to the storage device 200 via a transmission interface 101. The transmission interface 101 is a SATA interface, a PCIe interface, a USB interface, or an interface conforming to other transport protocols.

Wherein the host device 100 comprises a processor 11 and a host storage 12. The host storage 12 stores at least one first firmware 131. Each first firmware 131 defines an operation behavior of the storage device 200. The storage device 200 comprises a controller 21, a flash memory 22, and a first storage unit 23. The controller 21 is electrically connected to the flash memory 22 and first storage unit 23. The flash memory 22 is a memory space for storing data.

When the host device 100 of the present invention performs a firmware updating process for the storage device 200, it will transmit at least one first firmware 131 to the storage device 200 via the transmission interface 101. After the storage device 200 receives the first firmware 131, a loader unit 211 of the controller 21 loads the first firmware 131 into the first storage unit 23, and then executes at least one operation action according to the operation behavior defined by the first firmware 131.

In one example of the present invention, the operation behavior defined by the first firmware 131 is a data detection process, the controller 131 is able to perform the data detection process for the system data installed within the flash memory 22 of the storage device 200 by the use of the first firmware 131, so as to ensure the reliability of the system data. Otherwise, in another example of the present invention, the operation behavior defined by the first firmware 131 is an optimized scheduling process (or called as a data recombinant process), the controller 131 is able to perform the optimized scheduling process for the system data installed within the flash memory 22 of the storage device 200 by the use of the first firmware 131, such that the access operation for system data is able to accelerate. Besides, the above operation behaviors defined by the first firmware 131 are only parts of application embodiments of the present invention, person skilled in the art should understood that the host device 100 of the present invention may further provide various types of first firmware 131 having different purposes, and transmit those first firmware 131 to the storage device 200, so that the storage device 200 is able to execute various types of application processes.

In this case, when the storage device 200 of the present invention is in boot state, it will ready to receive the first firmware 131 provided by the host device 100, and therefore update firmware data, so as to increase the convenience in the firmware updating process.

The host storage 12 of the host device 100 further stores a firmware management program 13. The host device 13 may be select at least one first firmware 131, and then transmit the selected first firmware 131 to the storage device 200 via the firmware management program 13. Wherein the selected first firmware 131 will be used for defining the operation behavior to be executed by the storage device 200. In one embodiment of the present invention, the host device 100 is the server, which is connected with a lot of storage devices 200. The host device 100 transmits the first firmware 131 to all of the storage devices 200 via the use of the firmware management program 13, so that the firmware of all of the storage devices 200 may be updated in the same time.

In one embodiment of the present invention, the first storage unit 23 is a random access memory (RAM). The first firmware 131 is temporary stored in the first storage unit 23. When the storage device 200 is in shutdown state (or called as power outage state), the first firmware 131 temporary stored in the first storage unit 23 will disappear, so as to avoid other unauthorized host device to arbitrarily access the data of the flash memory 22 by the use of the first firmware 131 of the storage device 200.

In one embodiment of the present invention, the storage device 200 being installed with an operating system (OS) has become a main storage device of the host device 100. The storage device 200 further comprises a second storage unit 24 connected to the controller 21. The second storage unit 24 is a read only memory (ROM) and stores a second firmware 241. The second firmware 241 is a basic boot operation program. When the host device 100 is in boot state, the controller 21 of the storage device 200 will read the second firmware 241 stored in the second storage unit 24, preferentially, so that a boot process is allowed to be executed based on the boot operation defined by the second firmware 241.

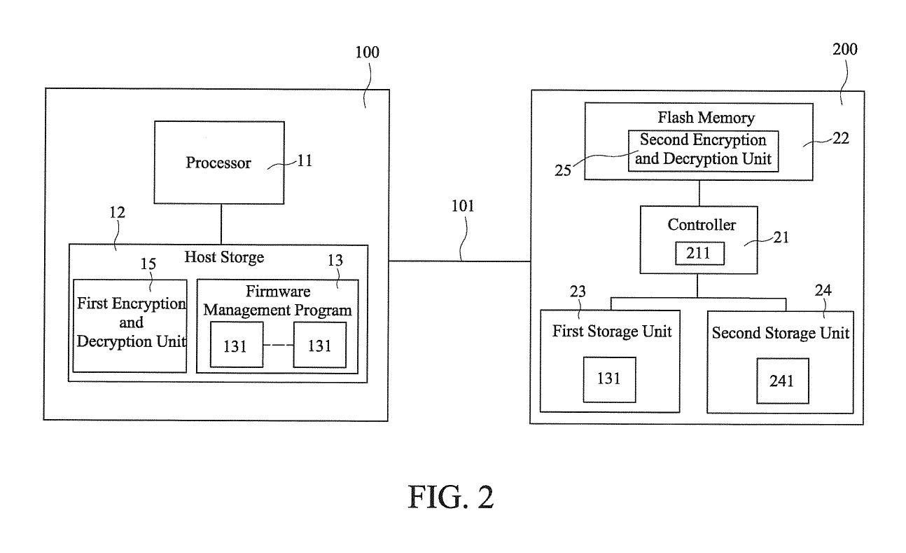

Referring to FIG. 2, there is shown a structural diagram of an architecture for updating firmware of storage device according to another embodiment of the present invention. As shown in FIG. 2, the host device 100 further comprises a first encryption and decryption unit 15, and the storage unit 200 further comprises a second encryption and decryption unit 25. The first encryption and decryption unit 15 and the second encryption and decryption unit 25 will be stored in the host storage 12 and the flash memory 22 based on software forms, respectively.

Before the host device 100 transmits the first firmware 131 to the storage device 200, the processor 11 of the host device 100 is able to encrypt the first firmware 131 via the first encryption and decryption unit 15, and then the host device 100 transmits the encrypted first firmware 131 to the storage device 200. After the storage device 200 receives the encrypted first firmware 131, the controller 21 of the storage device 200 is able to decrypt the encrypted first firmware 131 via the second encryption and decryption unit 25 to obtain the decrypted first firmware 131, and then the controller 21 of the storage device 200 loads the decrypted first firmware 131 into the first storage unit 23. In the case, it may ensure the safely in using the first firmware 131 by the disposition of the first encryption and decryption unit 15 and the second encryption and decryption unit 25.

In another embodiment of the present invention, of course, the first encryption and decryption unit 15 and the second encryption and decryption unit 25 are respectively configured in the internal circuit of the host device 100 and the storage device 200 based on hardware forms, in such a way that may also implement the encryption or decryption operation for the first firmware 131.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. An architecture for updating firmware of storage device, comprising:
a host device, comprising a processor and a host storage, said processor being connected to said host storage, wherein said host storage stores at least one first firmware, each said first firmware defines an operation behavior, respectively; and
at least one storage device, comprising a controller, a flash memory, and a first storage unit, said controller being connected to said flash memory and said first storage unit, when said host device transmits said first firmware to said storage device, said controller of said storage device loads said first firmware into said first storage unit, and executes at least one operation action according to said operation behavior defined by said first firmware.

2. The architecture according to claim 1, wherein said first storage unit is a random access memory, said first firmware is temporary stored in said first storage unit.

3. The architecture according to claim 1, wherein said storage device further comprises a second storage unit connected to said controller, said second storage unit is a read only memory and stores a second firmware, said controller of said storage device is allowed to execute a boot process by the use of said second firmware.

4. The architecture according to claim 1, wherein said host storage of said host device further stores a firmware management program, said host device selects at least one said first firmware, which is for defining said operation behavior to be executed by said storage device, via said firmware management program, and then transmits said selected first firmware to said storage device.

5. The architecture according to claim 4, wherein said host device is connected with a plurality of said storage devices, said host device transmits said first firmware to all of said storage devices via said firmware management program.

6. The architecture according to claim 1, wherein said controller comprises a loader unit, said first firmware is loaded into said first storage unit via said loader unit.

7. The architecture according to claim 1, wherein said host device further comprises a first encryption and decryption unit, said storage device further comprises a second encryption and decryption unit, said host device encrypts said first firmware via said first encryption and decryption unit, and said storage device decrypts said first firmware via said second encryption and decryption unit.

8. The architecture according to claim 7, wherein said first encryption and decryption unit and said second encryption and decryption unit are stored in said host storage and said flash memory based on software forms, respectively.

9. A method for updating firmware of storage device, said method applied to a firmware updating process between a host device and at least one storage device, said host device comprising a processor and a host storage, said host storage storing at least one first firmware, each said first firmware defining an operation behavior, respectively, said storage device comprising a controller and a first storage unit, said method comprising the following steps of:
transmitting said first firmware to said storage device via said host device;
receiving said first firmware and loading said first firmware into said first storage unit via said controller of said storage device; and
executing at least one operation action according to said operation behavior defined by said first firmware via said controller of said storage device.

10. The method according to claim 9, wherein said first storage unit is a random access memory, said first firmware is temporary stored in said first storage unit.

11. The method according to claim 9, wherein said storage device further comprises a second storage unit, said second storage unit is a read only memory and stores a second firmware, and said controller of said storage device is allowed to execute a boot process by the use of said second firmware.

12. The method according to claim 9, further comprising the following steps:
encrypting said first firmware before said host device transmits said first firmware; and
decrypting said first firmware after said storage device receives said first firmware.
